(19) United States
(12) Patent Application Publication
(10) Pub. No.: US 2006/0291952 A1
(43) Pub. Date: Dec. 28, 2006

(54) Structural member connector

(76) Inventor: O. George Wood, Maple Ridge (CA)

Correspondence Address: LONG AND CAMERON, SUITE 1401 - 1166 ALBERNI STREET, VANCOUVER, BC, V6E 3Z3, CA

(21) Appl. No.: 11/159,119

(22) Filed: Jun. 23, 2005

(51) Int. Cl. F16B 7/04

(52) U.S. Cl. 403/217

(57) ABSTRACT

A structural member connector for securing together a plurality of elongate members extending from a node, comprising a non-metallic holder member formed with a plurality of elongate recesses radiating from the node for receiving ends of the elongate members and having securement for the elongate members in the recesses. The connector is particularly suitable for geodesic dome connectors where the elongate members extend equiangularly spaced about a central axis and where the holder member is dome shaped and has a domed shaped cover to protect the connector.

### BACKGROUND OF THE INVENTION

1. Field of the Invention

The present invention relates to connectors for use in frames for structures, for example geodesic domes, formed of elongate members, e.g. pipes, tubes, dimensional lumber or the like.

2. Description of the Related Art

Geodesic domes are generally made of tubes or rods having ends connected at nodes. In the past, connectors employed to secure together the ends of the rods or tubes have normally been made of metal and were therefore expensive to manufacture and were also heavy and time consuming to install. Furthermore, tube or rod ends usually had to be flattened so the connections may be made with bolts, rivets or the like or had to be otherwise specially shaped for interengagement with the connectors.

### BRIEF SUMMARY OF THE INVENTION

It is accordingly an object of the present invention to provide a novel and improved structural member connector for interconnecting a plurality of elongate structural members at a single location. Such a connector, as well as being used in conventional structures, may also be used in geodesic domes and may be inexpensively molded from plastic material or fiberglass material which provides a lightweight connector which is simple to install.

According to the present invention, there is provided a structural member connector for securing together a plurality of elongate members extending from a node, comprising a non-metallic holder member formed with a plurality of elongate recesses radiating from the node for receiving ends of the elongate members and having securement for the elongate members in the recesses.

The connector may be domed shape to act as the top node or side nodes of a geodesic dome, or may be shaped for more conventional structures such as square or rectangular buildings with gable or shed type roof structures. Connectors may be made for any number of shapes with any number of elongate members, such as square, triangular, hexagonal, pentagonal and other shapes. Particular uses for such a structure include greenhouses, sheds and shelters.

The elongate structural members may be tubes or pipes, or in other cases may be dimensional lumber such as 2 by 4's or 2 by 2's as used for many structures.

In another embodiment of the present invention, there is provided a geodesic dome connector for securing together a plurality of elongate members extending equiangularly spaced about a central axis, the connector comprising a non-metallic dome shaped central holder member formed with a plurality of elongate recesses radiating equiangularly spaced about the central axis for receiving ends of the elongate members and the elongate recesses being equally inclined relative to the central axis, and a dome shaped clamp disc shaped to fit over the central tube holder.

The clamp disc fits over the central holder member and clamps the elongate members into the elongate recesses.

Furthermore, a top dome-shaped cover preferably extends over the clamp disc and may be used to clamp a flexible roofing material onto the clamp disc.

In other embodiments the elongate recesses are formed as sockets in the central holder member.

### BRIEF DESCRIPTION OF THE DRAWINGS

The present invention will be more readily understood from the following description of the preferred embodiment thereof, given by way of example, with reference to the accompanying drawings, in which:—

FIG. 1 shows an exploded view of a geodesic dome clamp according to the preferred embodiment of the present invention.

FIG. 2 shows a top view of the central tube holder member of the dome clamp shown in FIG. 1.

FIG. 3 shows a cross-sectional view taken at line 3-3 of FIG. 2.

FIG. 4 shows a sectional view taken at line 4-4 of FIG. 1 with the geodesic dome clamp fully assembled.

FIG. 5 shows a view in perspective of a modified dome connector.

FIG. 6 shows an overall view of a geodesic dome having five tube connectors for the top and side nodes, and four tube connectors for the base nodes.

FIG. 7 shows an elevational view of a five tube connector suitable for the geodesic dome shown in FIG. 6.

FIG. 8 shows an isometric view of a 4-tube connector for the base nodes of the geodesic dome shown in FIG. 6.

FIG. 9 shows an elevational view of another 4-tube connector suitable for a structural shape having a 90 degree corner.

FIG. 10 shows an overall view of another geodesic dome.

FIG. 11 shows an isometric view of a connector forming part of the dome of FIG. 10.

FIG. 12 shows a view corresponding to that of FIG. 11 but of a modification of the connector of FIG. 11.

FIG. 13 shows a view in transverse cross-section through a part of the connector of FIG. 11 and an end portion of a tube.

### DESCRIPTION OF THE PREFERRED EMBODIMENT

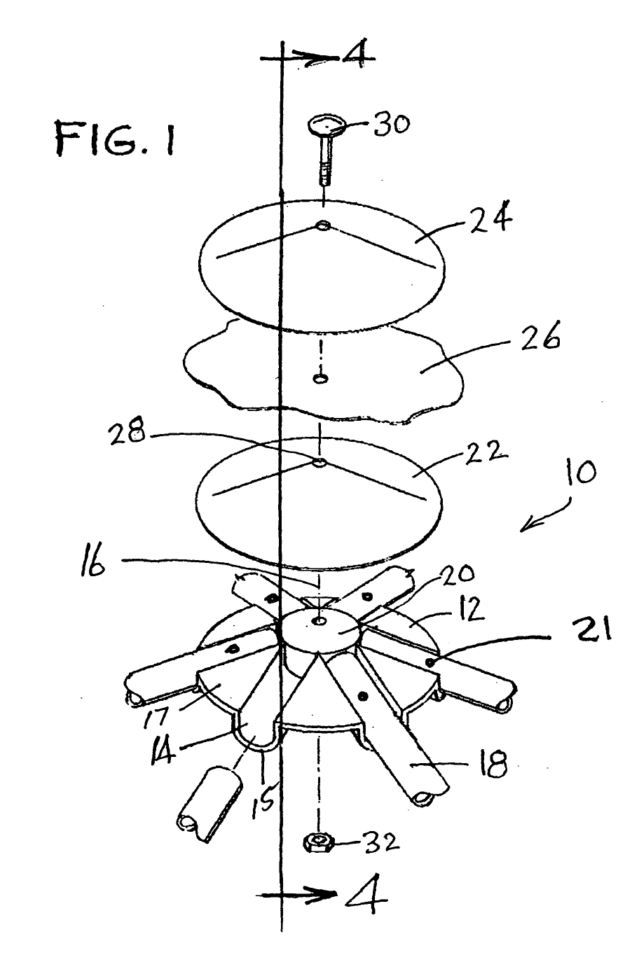

As shown in FIGS. 1, 2 and 3, a connector in the form of a top or side geodesic dome clamp indicated generally by reference numeral 10 has a central holder member 12 which is non-metallic, preferably molded from glass reinforced resin material and which is of a slightly domed shape with a dome angle which may be predetermined to suit a particular geodesic dome configuration. The clamp 10 may alternatively be made of injection molded plastic or metal. The holder member 12 is formed with a plurality of open topped elongate recesses 14 radiating from a central axis 16 with the elongate recesses 14 being equiangularly spaced about the axis 16 and subtending equal angles with the axis 16. The elongate recesses 14 are formed by cylindrically curved portions 15 of the holder member, which are connected to one another by webs 17, the outer ends of the cylindrically curved portions 15 and the outer edges of the webs 17 forming a circular periphery of the holder member 12. As can be seen, six elongate recesses 14 are provided in the holder member 12 to respectively receive six tubes 18, and a circular central hub 20 is provided at the central axis 16 which acts as an abutment so that each tube 18, when pushed into its respective elongate recess 14, comes to rest against the hub 20. Self-tapping screws 21 are provided to hold the tubes 18 to the central hub 20. If there is no need to dismantle the structure, then a suitable adhesive may be used to hold the tubes 18 in their respective elongate recesses 14. As will be explained hereafter, the number and position of the elongate recesses 14 may be changed to suit particular building structures.

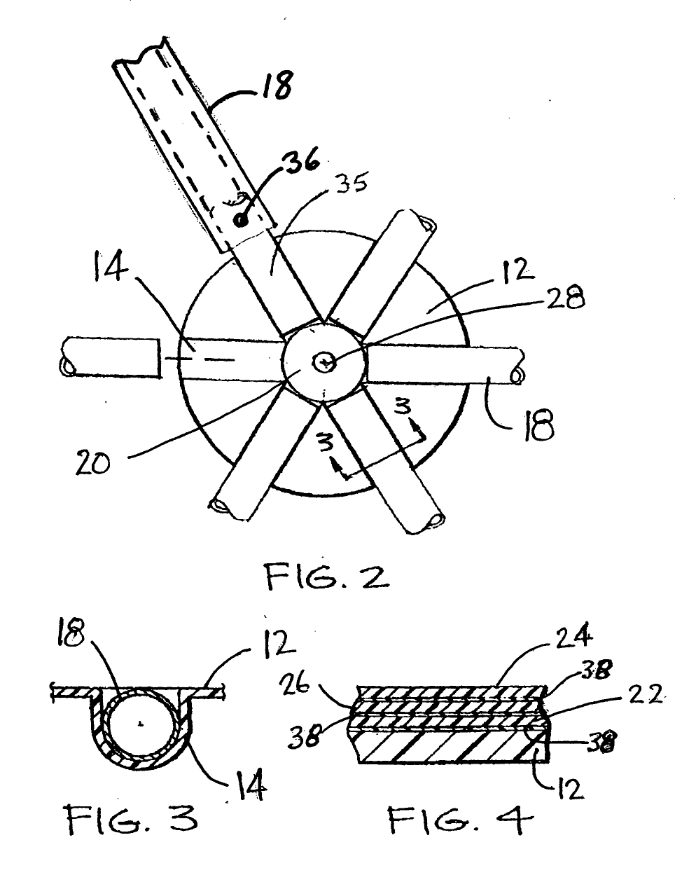

On top of the tube holder member 12 is a clamp disc 22, which is circular and domed to match the tube holder member 12. Whereas the clamp disc 22 is shown as circular, it may have a polygonal shape to match the number of tubes. The clamp disc 22 is an optional feature which may be omitted in many instances. A top dome cover 24, which is primarily the same shape as the clamp disc 22, fits over the clamp disc and grips flexible roofing material 26 positioned therebetween. An attachment hole 28 at the central axis 16 permits a bolt 30 to pass therethrough into threaded engagement with a nut 32 to secure the top dome cover 24, the clamp disc 22 and the central holder 12 together. The flexible roofing material 26 is clamped between the top dome cover 24 and the clamp disc 22, and the ends of the tubes 18 are clamped between the central holder 12 and the clamp disc 22 and thereby held in place up against the hub 20. The positioning of the tubes 18 in the elongate recesses 14 may be seen in more detail in FIGS. 2 and 3. In another embodiment, the ends of the tubes 18 may be tapered to fit into the elongate recesses 14, or as shown in FIG. 2, the ends of the tubes 18 may fit over stub shafts 35 forming elongate shaped portions of the connector and extending from and joined to the elongate recesses 14, the tubes being held to the stub shafts by screws 36.

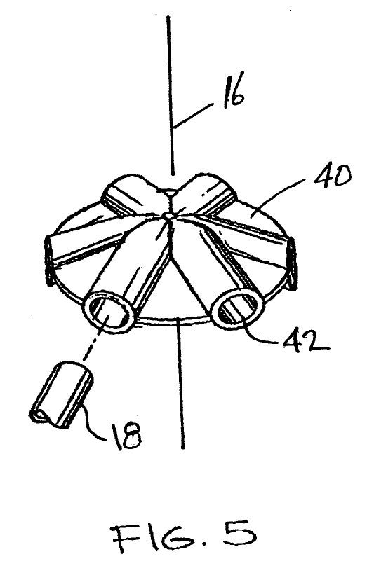

A partial cross-section of a modification of the geodesic dome connector 12 is shown in FIG. 4, wherein the flexible roofing material 26 is shown gripped between the top dome cover 24 and the clamp disc 22. In this embodiment of the invention, the nut 32 and the bolt 30 are omitted and the components of the connector are instead secured together by adhesive. More particularly, adhesive 38 is shown on opposite sides of the clamp disc 22 and the flexible roofing material 26, to ensure that the clamp is waterproof. Adhesive is also placed between the clamp disc 22 and the central tube holder member 12.

Another embodiment of the central tube holder 40 is shown in FIG. 5, wherein the member 40 has elongate shaped portions in the form of molded tube sockets 42 integrally formed therein and extending radially from a node to hold the ends of the tubes 18. The sockets 42 are a predetermined length, so that the tubes 18 are positioned and are equally spaced from the central axis 16.

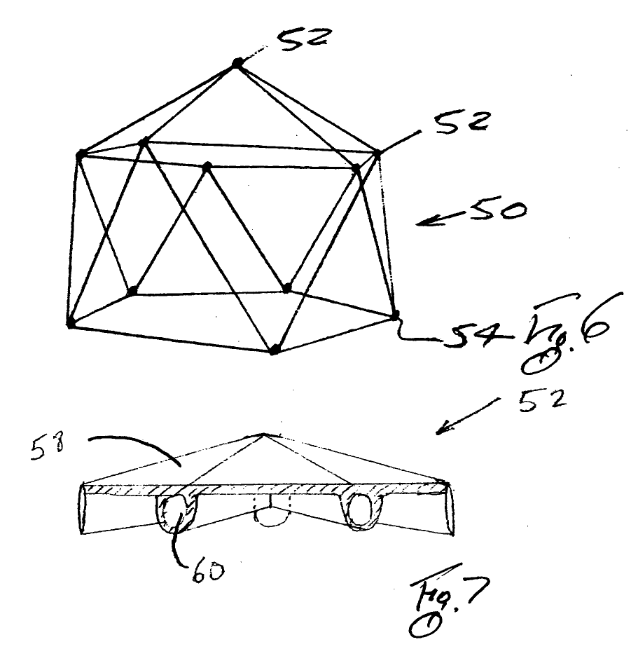

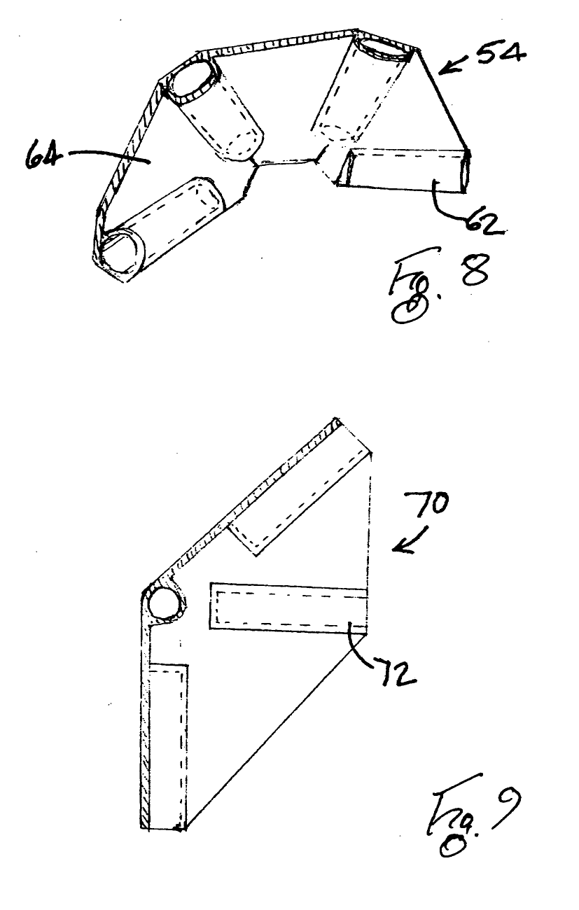

FIG. 6 illustrates a particular type of geodesic dome 50 which has 5-tube node connectors 52 at the top and sides, and 4-tube base node connectors 54 at the bottom of the dome 50. The 5-tube node connector 52 shown in FIG. 7 is an integral molded unit and has five sides 58 sloped upwards so tube receiving holes 60 have an angle to suit the dimensions and shape of the geodesic dome 50. The 4-tube connector 54 shown in FIG. 7 is also an integral molded unit and has four tube receiving holes 62 positioned by a panel 64. The two lowest tube receiving holes are on the same plain so the tubes form the base of the geodesic dome 50.

FIG. 9 shows another embodiment of a connector 70 which has four elongate shaped portions I the form of tube-receiving holes 72 integrally molded with a panel 74 to form a connector that can be used with a structure that has walls or panels at right angles to each other. Whereas four tube-receiving holes and a particular shape and configuration shown, it will be apparent to those skilled in the art that different configurations with different numbers of tube receiving holes may be provided to suit different configurations of structures.

All of the above-described embodiments of the present invention have receiving recesses or holes for interengagement with tubes or pipes. However the receiving holes may be shaped to take dimensioned lumber such as 2 by 4's or 2 by 2's. The pipe or tube sizes may vary depending on the size of the structure. In some instances, receiving holes in a particular connector may be designed to take different sizes and shapes of elongate members.

In the above described embodiments of the present invention, the central tube holder member 12 is formed of fibreglass. However, other suitable plastic materials may be used, depending on the requirements of construction. Also, the tubes 18 may be replaced by rods, dimensioned lumber or any other elongate members suitable for use in different types of structures.

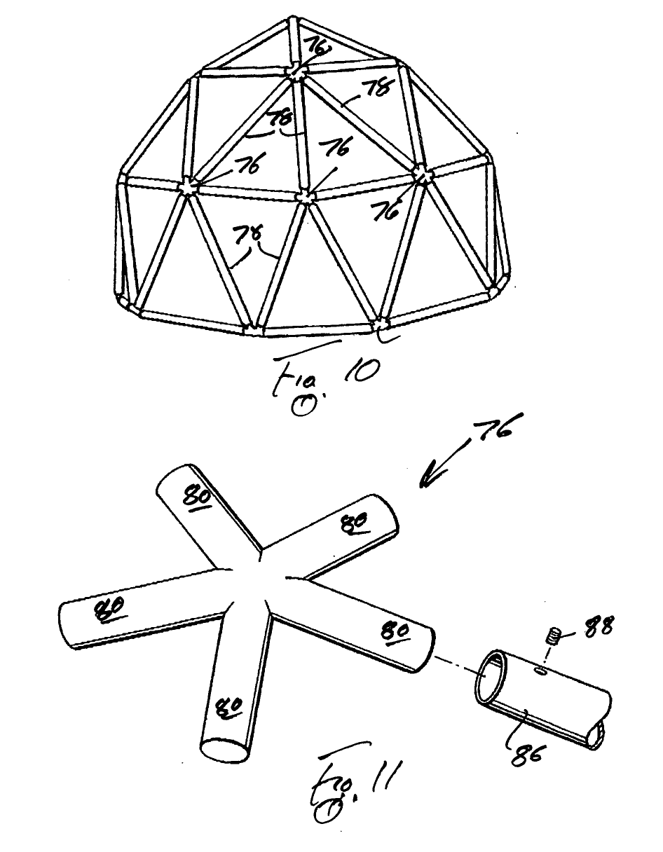

FIG. 10 shows another geodesic dome, which employs connectors 76, which are different from the connectors described above, to connect together elongate structural members in the form of tubes 78.

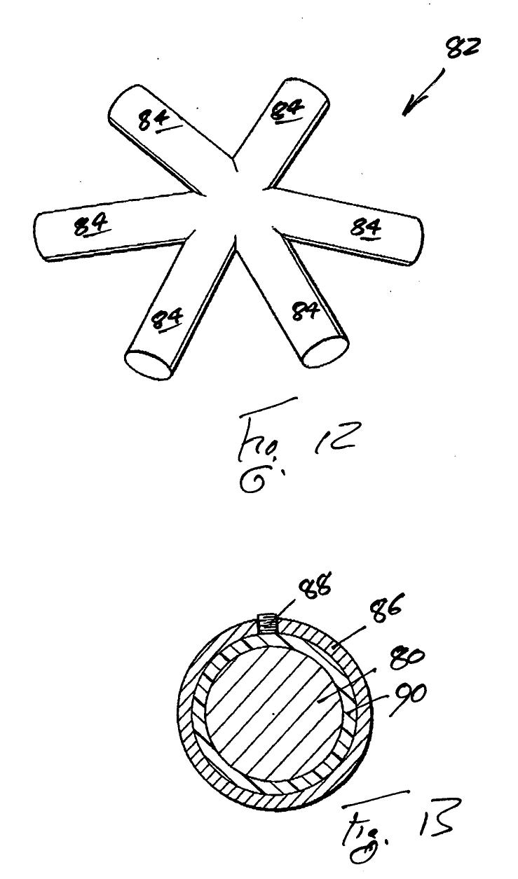

One of the connectors 76 is shown in FIG. 11 and has five elongate projections or fingers 80 radiating from a node. The connector 76 is made of molded fiberglass or plastic, and may be formed with a greater or lesser number of projections 80. For example, FIG. 12 shows a modification of the connector 76 which is indicated generally by reference numeral 82 and which has six elongate projections 84.

FIG. 11 also shows an end portion 86 of one of the tubes 78 being fitted onto one of the projections 80, with a grub screw 88 for securing the tube end portion 86 to its projection 80, as shown in FIG. 13. If required, the projections 80 can be reinforced by metal sleeves, one of which is shown in FIG. 13 and indicated by reference numeral 90.

Various changes may be made to the embodiments shown herein without departing from the scope of the present invention, which is limited only by the following claims.

I claim:

1. A structural member connector for securing together a plurality of elongate members extending from a node, comprising:—
a non-metallic holder molded member formed with a plurality of elongate recesses radiating from the node for receiving ends of the elongate members, and having securement for the elongate members in the recesses.

2. The structural member connector according to claim 1, wherein the connector is molded in a dome shaped configuration with the elongate recesses equiangularly spaced about a central axis and equally inclined relative to said central axis.

3. The structural member connector according to claim 1, wherein the connector has one flat side for a base node and comprises a plurality of elongate recesses projecting on a base plane and angularly upwards.

4. The structural member connector according to claim 1, wherein the connector has a plurality of elongate recesses, at least one of said recesses being at an angle of about 90 degrees to another of said elongate recesses to form a node with at least one 90 degree angle.

5. The structural member connector according to claim 1, wherein the holder is molded from fiberglass.

6. The structural member connector according to claim 1, wherein the holder is formed of injection molded plastic.

7. The structural member connector according to claim 1, wherein the elongate recesses are shaped to hold tubular members.

8. The structural member connector according to claim 1, wherein the elongate recesses are shaped to receive dimensional lumber.

9. A geodesic dome connector for securing together a plurality of elongate members extending equiangularly spaced about a central axis, comprising:—
a dome-shaped central molded holder member of non-metallic material, said holder member being formed with a plurality of elongate recesses radiating equiangularly spaced about the central axis for receiving ends of said elongate members and said elongate recesses being equally inclined relative to said central axis, and
a dome-shaped clamp disc shaped to fit over said central tube holder member.

10. The geodesic dome connector as claimed in claim 9, further comprising a roofing sheet material on said clamp member and a dome-shaped top cover clamping said roofing sheet material onto said clamp disc.

11. The geodesic dome connector as claimed in claim 10, including a connector member extending along said central axis through said holder member, said clamp disc and said top cover and securing said holder member, said clamp disc and said top cover to one another.

12. The geodesic dome connector as claimed in claim 10, wherein adhesive is provided between said central holder, said clamp disc, said roofing sheet material and said top cover.

13. The geodesic dome clamp according to claim 9, wherein said elongate recesses comprise open-topped grooves.

14. The geodesic dome clamp according to claim 11, wherein six tube holders are positioned equidistant about the central axis.

15. The geodesic dome clamp according to claim 9, wherein the tube holders comprise sockets formed integrally with the central tube holder member.

16. A structural assembly, comprising:
a plurality of elongate structural members;
a connecter of molded material connecting the elongate structural members to one another with the structural members radiating from a node;
the connector having elongate shaped portions radiates from a node; and
the shaped portions and the structural members being shaped to interengaged with one another.

17. A structural assembly as claimed in claim 16, wherein the shaped portions comprise open topped recesses molded in the connector and receiving the structural members.

18. A structural assembly as claimed in claim 17, wherein the connector comprises a dome-shaped central molded holder member of non-metallic material, said shaped portions comprising elongate recesses molded in the holder member and radiating equiangularly spaced about the central axis for receiving ends of said structural members and said elongate recesses being equally inclined relative to said central axis, and a dome-shaped clamp disc shaped to fit over said central tube holder member.

19. A structural assembly as claimed in claim 16, wherein the structural members are tubular and the shaped portions of the connector comprise elongate projections received in the tubular structural members.
